(19) United States
(12) Patent Application Publication
(10) Pub. No.: US 2022/0364945 A1
(43) Pub. Date: Nov. 17, 2022

(54) PRESSURE SENSOR APPARATUS

(71) Applicant: FUJI ELECTRIC CO., LTD., Kanagawa (JP)

(72) Inventors: Hiroto KIKUCHI, Matsumoto-city (JP); Kazuhiro MATSUNAMI, Matsumoto-city (JP); Kimihiro ASHINO, Matsumoto-city (JP)

(21) Appl. No.: 17/728,983

(22) Filed: Apr. 26, 2022

(30) Foreign Application Priority Data
May 17, 2021 (JP) 2021-083193

(51) Int. Cl. G01L 19/14; G01L 19/00

(52) U.S. Cl. CPC G01L 19/143; G01L 19/0084

(57) ABSTRACT

Provided is a pressure sensor apparatus, including: a pressure sensor unit; a case configured to house the pressure sensor unit; and a plurality of lead terminals configured to be exposed toward outside of of the case, wherein the plurality of lead terminals include a first terminal, a second terminal, and a ground terminal; and the ground terminal, the first terminal and the second terminal are arranged in an order of the ground terminal, the first terminal, and the second terminal outside the case. The pressure sensor apparatus includes a capacitor for a second terminal arranged across the ground terminal and the second terminal in between in interior of the case.

The contents of the following Japanese patent application are incorporated herein by reference:

No. 2021-083193 filed in JP on May 17, 2021.

### BACKGROUND

### 1. Technical Field

The present invention relates to a pressure sensor apparatus.

A pressure sensor apparatus is known to have a chip capacitor for noise reduction provided across the adjacent lead terminals (for example, refer to Patent Document 1). A pressure sensor apparatus is also known in which the resin case includes a protruding wall portion that surrounds the pressure sensor unit and a chip capacitor is placed at a position below the wall portion (refer to Reference Document 2).

### PRIOR ART DOCUMENT

[Patent Document]
Patent Document 1: Japanese Patent Application Publication No. 2007-286015
Patent Document 2: Japanese Patent Application Publication No. 2016-61661

### BRIEF DESCRIPTION OF THE DRAWINGS

FIG. 1 schematically illustrates a pressure sensor apparatus 1 in one embodiment of the present invention.

FIG. 2 illustrates a sectional view schematically showing the pressure sensor apparatus 1.

FIG. 3 schematically illustrates the pressure sensor apparatus 1 when seen from a back surface side.

FIG. 4 schematically illustrates a positional relationship between a wall portion and each capacitor.

FIG. 5 illustrates a pressure sensor apparatus 2 in a comparative example.

FIG. 6 illustrates one example of an output signal of the pressure sensor apparatus 1 in one embodiment of the present invention.

FIG. 7 illustrates one example of an output signal of a pressure sensor apparatus 2 in the comparative example.

### DESCRIPTION OF EXEMPLARY EMBODIMENTS

The following describes the present invention by referring to embodiments thereof.

However, the embodiments described hereinafter do not limit the invention as in the claims. And all the combinations of the features described in the embodiment(s) are not necessarily essential to means provided by aspects of the invention.

Herein, one side in the direction parallel to the depth direction of the pressure sensor unit is referred to as “upper” and the other side as “lower”. Of the two main surfaces of the pressure sensor unit, one surface is referred to as the upper surface and the other surface as the lower surface. The “upper” and “lower” directions are not limited to the gravitational direction.

In the present specification, technical matters may be described using orthogonal coordinate axes of an X axis, a Y axis, and a Z axis. Herein, the plane parallel to the upper surface of the pressure sensor unit is the XY plane, and the depth direction of the pressure sensor unit is the Z axis. In particular, the side of the pressure sensor unit and lead terminal that is wire-bonded is referred to as the “front surface”, and the side that is not wire-bonded is referred to as the “back surface”.

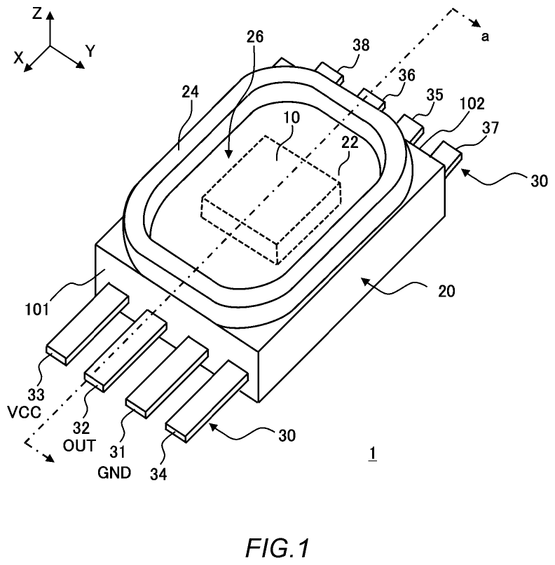

FIG. 1 schematically illustrates a pressure sensor apparatus 1 in one embodiment of the present invention. The pressure sensor apparatus 1 is a semiconductor pressure sensor, and is utilized in a wide range of fields such as automotive. It is desired that the pressure sensor apparatus 1 should be compact and lightweight, low cost, and have improved quality and reliability, as well as prevent malfunction due to noise and electromagnetic waves. The pressure sensor apparatus 1 of the present embodiment reduces noise as well as improves the quality of the output waveform through the arrangement and configuration of a plurality of lead terminals and the capacitors provided between the lead terminals.

The pressure sensor apparatus 1 includes a pressure sensor unit 10, a case 20 and a plurality of lead terminals 30. Since the pressure sensor unit 10 is covered by the protectant, the pressure sensor unit 10 is not exposed from the upper surface of the pressure sensor apparatus 1. In FIG. 1, the pressure sensor unit 10 is illustrated by a dotted line for description.

The pressure sensor unit 10 may be an absolute pressure sensor. The absolute pressure sensor is a sensor configured to measure a differential pressure between a pressure in a sealed space arranged on the lower surface side of the diaphragm, and a pressure in a space to be measured on the upper surface side of the diaphragm. The pressure in the sealed space is, as one example, vacuum pressure.

The pressure sensor unit 10 detects pressure from the space to be measured. The pressure sensor unit 10 converts pressure to an electrical signal. The pressure sensor unit 10, as one example, has a piezoresistive element that produces a change in resistance value in response to applied pressure. The piezoresistive element may be a diffusion resistive element formed on a semiconductor substrate such as silicon. The piezoresistor, for example, constitutes a Wheatstone bridge, and when a current or voltage is applied, a potential difference proportional to the pressure is obtained.

The case 20 houses the pressure sensor unit 10. The case 20 includes a base portion 22 and a wall portion 24. In the base portion 22, a pressure sensor unit 10 is arranged. The wall portion 24 is provided so as to surround the pressure sensor unit 10 on an upper surface of the base portion 22. The case 20 forms a concave portion 26 by the base portion 22 and the wall portion 24.

The base portion 22 and the wall portion 24 are formed of, as one example, resin. The wall portion 24 may be provided integrally with the base portion 22. The wall portion 24 has a cylindrical shape, as one example. The upper portion of the cylindrical shape is formed into an open end connected to the space to be measured.

The plurality of lead terminals 30 are external terminals that electrically connect the pressure sensor unit 10 with external wires. The plurality of lead terminals 30 include a ground terminal 31, a first terminal 32 and a second terminal 33. The first terminal 32 corresponds to one of an output terminal OUT and a power source terminal VCC. The second terminal 33 corresponds to the other one of the output terminal OUT and the power source terminal VCC. The output terminal OUT outputs a signal based on an electrical signal. The power source terminal VCC supplies electrical power to the pressure sensor unit 10. In this example, the first terminal 32 is the output terminal OUT, and the second terminal 33 is the power source terminal VCC. On the other hand, the first terminal 32 may be a power source terminal VCC, and the second terminal 33 may be an output terminal OUT.

The ground terminal 31, the first terminal 32 and the second terminal 33 are arranged in an order of the ground terminal 31, the first terminal 32 and the second terminal 33 outside the case 20. In this example, the ground terminal 31, the first terminal 32 and the second terminal 33 are arranged in an order of the ground terminal 31, the first terminal 32 and the second terminal 33 from the+direction to the−direction in the Y axis. However, the terminals may also be arranged in an order of the ground terminal 31, the first terminal 32 and the second terminal 33 from the−direction to the +direction in the Y axis. It should be noted that the case where another terminal is provided between the ground terminal 31, the first terminal 32 and the second terminal 33 is included in the case where the terminals are arranged in the order of the ground terminal 31, the first terminal 32 and the second terminal 33, only if the terminals are arranged in an order of the ground terminal 31, the first terminal 32 and the second terminal 33.

The plurality of lead terminals 30 may also include a terminal other than the ground terminal 31, the first terminal 32 and the second terminal 33. In this example, the plurality of lead terminals 30 include a temperature compensation terminal 34 and various of auxiliary terminals 35, 36, 37 and 38. The case 20 includes a first surface 101 from which the ground terminal 31, the first terminal 32 and the second terminal 33 are exposed, and a second surface 102 located on the opposite side to the first surface 101 sandwiching the pressure sensor unit 10. The plurality of auxiliary terminals 35, 36, 37 and 38 may be exposed from the second surface 102 to the outside of the case 20. In this example, the temperature compensation terminal 34 is exposed from the first surface 101 to the outside of the case 20, similar to the ground terminal 31, the first terminal 32 and the second terminal 33. In this example, the temperature compensation terminal 34 is provided on the opposite side of the first terminal 32, sandwiching the ground terminal 31. However, the position of the temperature compensation terminal 34 is not limited to this case, and may be not provided with the temperature compensation terminal 34.

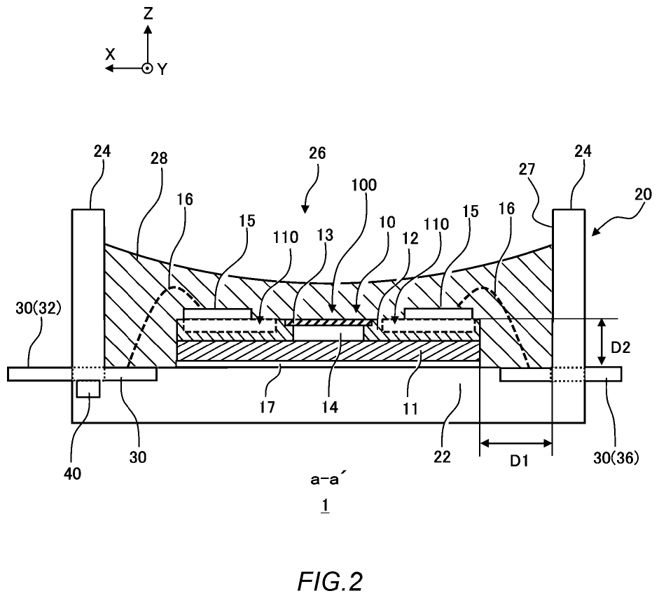

FIG. 2 illustrates a sectional view schematically showing the pressure sensor apparatus 1. FIG. 2 schematically illustrates one example of a-a′ cross section in FIG. 1.

The pressure sensor unit 10 includes a support substrate 11 and a pressure sensor chip 12. The support substrate 11 is formed of an insulating material such as glass. The pressure sensor chip 12 is fixed to the support substrate 11. The pressure sensor chip 12 is formed of a semiconductor material such as silicon. On the upper surface side of the pressure sensor chip 12, a pressure sensor portion 100 and a control circuit portion 110 (illustrated by a dotted line) in its surroundings are provided. The pressure sensor portion 100 is provided with a diaphragm structure 13. The main surface of the diaphragm structure 13 has a plurality of semiconductor distortion gauges (not illustrated) formed of a material with a piezoresistor effect being connected thereto. The control circuit portion 110 includes a circuit for performing amplification or adjustment of the output of the pressure sensor portion 100. The plurality of auxiliary terminals 35, 36, 37 and 38 may be connected electrically to a circuit that adjusts the output of the pressure sensor portion 100 inside the control circuit portion 110, or may be used for the input and output of the data for adjustment.

In the pressure sensor chip 12, a sealed space 14 is provided below the diaphragm structure 13. The sealed space 14 of this example may be a vacuum reference chamber formed by bonding the diaphragm structure 13 and the support substrate 11 in vacuum. In the pressure sensor unit 10, the resistance of the semiconductor distortion gauge changes according to the differential pressure between the pressure in the sealed space 14 and the pressure in the space to be measured applied to the diaphragm structure 13, and the amount of change is output as an electrical signal.

On the upper surface of the pressure sensor chip 12, an electrode pad 15 is provided via an insulating film (not illustrated). The electrode pad 15 is electrically connected with the lead terminal 30 by the bonding wire 16 inside the case 20. The bonding wire 16 may be formed of aluminum. The pressure sensor unit 10 is fixed in the interior of the case 20 by an adhesive material 17. Although the pressure sensor portion 100 and the control circuit portion 110 of the pressure sensor unit 10 are formed in a same chip in this example, the pressure sensor portion 100 and the control circuit portion 110 may be formed in different semiconductor chips, and the pressure sensor unit 10 may be configured by a plurality of chips. The plurality of chips can be electrically connected using bonding wires.

The pressure sensor unit 10 may obtain a digital signal by analog-digital conversion of the analog signal, which is the result of pressure measurement based on the amount of change in resistance of the semiconductor distortion gauges, and may output the digital signal from the output terminal OUT.

The case 20 is filled with a protectant 28 to cover the upper surface of the pressure sensor unit 10. The protectant 28 protects the pressure sensor unit 10 and bonding wires 16 from the pressure medium. The protectant 28 is formed of a gel such as a silicon gel.

It is desired that the distance D1 between the side surface of the pressure sensor unit 10 and the opposite side surface of the case 20 is greater than or equal to the depth D2 from the upper surface of the base portion 22 to the upper surface of the pressure sensor unit 10. That is, it is desired that D1/D2≥1. In this example, the inner surface of the case 20 opposite to the side surface of the pressure sensor unit 10 is the inner surface 27 of the wall portion 24. In this example, the base portion 22 is in a flat shape without providing any step between the side surface of the pressure sensor unit 10 and the inner surface 27 of the wall portion 24. With such a configuration, the distance D1 can be increased and the depth D2 can be decreased.

Increasing the distance D1 between the pressure sensor chip 12 of the pressure sensor unit 10 and the inner surface of the case 20 and decreasing the depth D2 to make D1/D2≥1 can prevent stress concentration on the surface of the protectant 28 when pressure is applied to the applied protectant 28, thereby reducing the risk of damage to the protectant 28.

As described below, the pressure sensor apparatus 1 has a capacitor 40 for the first terminal between the ground terminal 31 and the first terminal 32. The pressure sensor apparatus 1 also has a capacitor 41 for the second terminal between the ground terminal 31 and the second terminal 33. By making the base portion 22 be in a flat shape without providing steps between the side surface of the pressure sensor unit 10 and the inner surface 27 of the wall portion 24, the thickness of the base portion 22 is reduced, which may cause the base portion 22 to deform easily. Accordingly, even if the base portion 22 is deformed, it is desired to suppress the deformation of the portions where the capacitor 40 for the first terminal and the capacitor 41 for the second terminal are arranged. According to this example, the capacitor 40 for the first terminal and the capacitor 41 for the second terminal are respectively arranged in a position overlapping with the wall portion 24 in a top view. A top view means a case when seen from the +Z axis direction. The deformation in the portion where the capacitor 40 for the first terminal and the capacitor 41 for the second terminal are arranged can be suppressed.

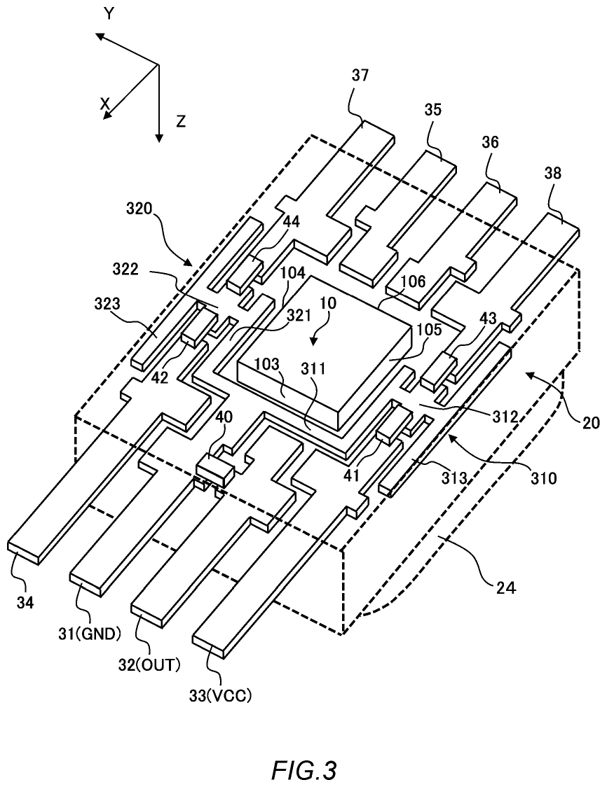

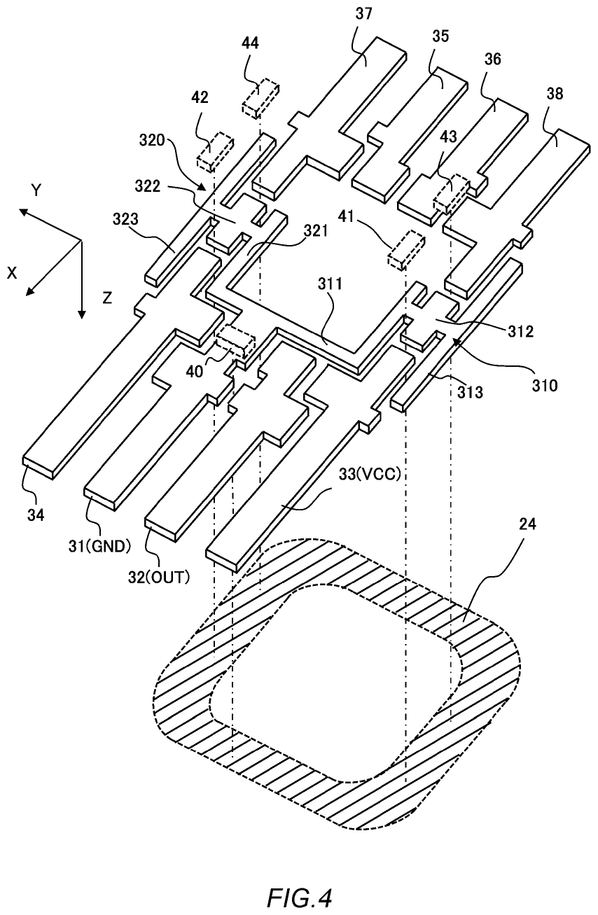

FIG. 3 schematically illustrates a pressure sensor apparatus 1 when seen from the back surface side. FIG. 4 schematically illustrates a positional relationship between the wall portion and each capacitor. It should be noted that in FIG. 3, the case 20 is illustrated by a dotted line. In FIG. 4, the position of the wall portion 24 of the case 20 is schematically illustrated by hatching.

In FIG. 3, the pressure sensor apparatus 1 includes a capacitor 41 for the second terminal, which is arranged inside the case 20, spanning between the ground terminal 31 and the second terminal 33. Furthermore, the pressure sensor apparatus 1 includes a capacitor 40 for the first terminal, which is arranged inside the case 20, spanning between the ground terminal 31 and the first terminal 32. The capacitor 40 for the first terminal and the capacitor 41 for the second terminal may be arranged on the back surface of the lead terminal 30.

The capacitor arranged between the ground terminal 31 and the power source terminal VCC (the capacitor 41 for the second terminal in FIG. 3) has a lower impedance at high frequencies, allowing high frequency noise to escape to ground. A capacitor arranged between the ground terminal 31 and the output terminal OUT (the capacitor 40 for the first terminal in FIG. 3) removes noise components superimposed on the output signal by electromagnetic waves and so on. A capacitor arranged between the ground terminal 31 and the output terminal OUT prevents malfunction and damage to the pressure sensor unit 10 caused by static electricity.

The ground terminal 31, the first terminal 32 and the second terminal 33 are arranged in an order of the ground terminal 31, the first terminal 32 and the second terminal 33 outside the case 20. In this case, since the ground terminal 31 and the first terminal 32 are arranged adjacent to each other, it is easy to arrange the capacitor 40 for the first terminal across the ground terminal 31 and the first terminal 32. On the other hand, since the ground terminal 31 and the second terminal 33 are not arranged adjacent to each other outside the case 20, it is difficult to arrange the capacitor 41 for the second terminal across the ground terminal 31 and the second terminal 33.

Different from the present embodiment, when the first terminal 32 and the second terminal 33 are arranged on both sides of the ground terminal 31 with reference to the ground terminal 31 outside the case 20, it is easy to arrange a capacitor between the ground terminal 31 and the first terminal 32, and between the ground terminal 31 and the second terminal 33, respectively, but the terminal arrangement is limited. Specifically, it can only be applied when the power source terminal VCC and the ground terminal 31 are adjacent to each other.

In the present embodiment, the ground terminal 31 is stretched and drawn around inside the case 20. In this way, the capacitor 41 for the second terminal can be arranged spanning between terminals even between the second terminal 33, which is not adjacent to the ground terminal 31, and the ground terminal 31.

In this example, as shown in FIG. 4, the ground terminal 31 extends up to the position where the capacitor 41 for the second terminal overlaps with the wall portion 24 in a top view. In one example, one end of the ground terminal 31 exposes toward the outside of the case 20. The other end of the ground terminal 31 is split into the first extending portion 310 and the second extending portion 320. The first extending portion 310 and the second extending portion 320 are arranged sandwiching the pressure sensor unit 10. As shown in FIG. 4, the first extending portion 310 and the second extending portion 320 respectively extends up to the wall portion 24. However, in the present embodiment, it is not limited to this case, and in one example, the second extending portion 320 may be omitted. Also, the ground terminal 31 may be split into three or more branches.

The first extending portion 310 may includes a first wire routing portion 311, a first pad portion 312 and a first extending portion 313 in one example. The first wire routing portion 311 extends up to a position adjacent to the second terminal 33 through a space between the first terminal 32 and the pressure sensor unit 10. The first pad portion 312 is coupled to the first wire routing portion 311 and faces the second terminal 33 with a gap therebetween. The capacitor 41 for the second terminal is provided across the first pad portion 312 and the second terminal 33 in between. The first extending portion 313 is a part further extended from the first pad portion 312. In this example, the first extending portion 313 extends in the X axis direction along the side surface of the case 20.

The second extending portion 320 includes a second wire routing portion 321, a second pad portion 322 and a second extending portion 323 in one example. The second wire routing portion 321 extends up to a position adjacent to the temperature compensation terminal 34 from the division point with the first wire routing portion 311. The second pad portion 322 is coupled to the second wire routing portion 321 and faces the temperature compensation terminal 34 with a gap therebetween. The capacitor 42 for the temperature compensation terminal is arranged across the space between the second pad portion 322 and the temperature compensation terminal 34.

As shown in FIG. 3, the other end of the ground terminal 31 may extend at least along the edge 103, the edge 104, and the edge 105 of the pressure sensor unit 10. In this example, the first wire routing portion 311 and the second wire routing portion 321 extend along three edges of the pressure sensor unit 10.

The pressure sensor apparatus 1 may further include, in the case 20, the capacitors 43 and 44 for the auxiliary terminal arranged spanning between at least some of the plurality of auxiliary terminals 35, 36, 37, 38 and the ground terminal 31. As one example, the capacitor 43 for the auxiliary terminal may be provided between the auxiliary terminal 38 and the ground terminal 31, and the capacitor 44 for the auxiliary terminal may be provided between the auxiliary terminal 37 and the ground terminal 31. On the other hand, the auxiliary terminal 35 and the auxiliary terminal 36 may not be connected to the ground terminal 31 via the capacitor for the auxiliary terminal. In other words, the plurality of auxiliary terminals 35, 36, 37, 38 may include a first auxiliary terminal group (37, 38) connected to the ground terminal 31 via the capacitors 43, 44 for the auxiliary terminal inside the case 20, and a second auxiliary terminal group (35, 36) that is not connected to the ground terminal 31 via the capacitors 43, 44 for the auxiliary terminal. The second auxiliary terminal group (35, 36) becomes terminals more resistant to noise than the first auxiliary terminal group (37, 38). As one example, the first auxiliary terminal group (37, 38) may be an input/output terminal of the analog signal, and the second auxiliary terminal group (35, 36) may be an input/output terminal of the digital signal. The terminal that inputs the digital signal is connected to the ground through the pull down resistor, which is not illustrated. Also, since the input impedance is high, the noise escapes to the ground via the pull down resistor. Accordingly, the connection to the ground terminal 31 via the capacitor can be omitted. This can reduce the area over which the ground terminal 31 is pulled.

Particularly, in this example, the second terminal 33 and the auxiliary terminal 38 extend in the longitudinal direction, and the end surfaces face each other with a gap between them. The first pad portion 312 is provided in this gap. Then, the capacitor 41 for the second terminal is provided spanning between the first pad portion 312 and the second terminal 33, and a capacitor 43 for the auxiliary terminal is provided spanning between the first pad portion 312 and the auxiliary terminal 38. Accordingly, the first pad portion 312 can be used, as a common pad portion, in the capacitor 41 for the second terminal and the capacitor 43 for the auxiliary terminal. This can achieve saving space compared to a case of using separate pad portions.

Similarly, the second pad portion 322 can be used, as a common pad portion, in the capacitor 42 for the temperature compensation terminal and the capacitor 44 for the auxiliary terminal. This can achieve saving space compared to a case of using separate pad portions.

It should be noted that the capacitor 40 for the first terminal, the capacitor 41 for the second terminal, the capacitor 42 for the temperature compensation terminal, the capacitor 43 for the auxiliary terminal and the capacitor 44 for the auxiliary terminal may be a chip capacitor. The capacitor 40 for the first terminal, the capacitor 41 for the second terminal, the capacitor 42 for the temperature compensation terminal, the capacitor 43 for the auxiliary terminal and the capacitor 44 for the auxiliary terminal may be connected to the corresponding lead terminal 30 by solder bonding.

Also, after solder bonding the capacitor 40 for the first terminal, the capacitor 41 for the second terminal, the capacitor 42 for the temperature compensation terminal, the capacitor 43 for the auxiliary terminal and the capacitor 44 for the auxiliary terminal to each lead terminal, each capacitor may be embodied inside the resin constitutes the case 20 by insert resin molding. The capacitor 40 for the first terminal, the capacitor 41 for the second terminal, the capacitor 42 for the temperature compensation terminal, the capacitor 43 for the auxiliary terminal and the capacitor 44 for the auxiliary terminal may be respectively arranged on the back surface of the lead terminal 30. By arranging on the back surface, the interference with bonding wires can be avoided.

The electrostatic capacitance of the capacitor 40 for the first terminal, the capacitor 41 for the second terminal, the capacitor 42 for the temperature compensation terminal, the capacitor 43 for the auxiliary terminal and the capacitor 44 for the auxiliary terminal may be properly selected. Particularly, the electrostatic capacitance of the capacitor between the ground terminal 31 and the output terminal VCC may be arbitrarily selected based on the time constant calculated so that the output digital signal (square wave) becomes a waveform that can be read by subsequent receiving apparatus. Also, the electrostatic capacitance of the capacitor between the ground terminal 31 and the power source terminal VOUT may be selected arbitrarily according to the noise to be reduced.

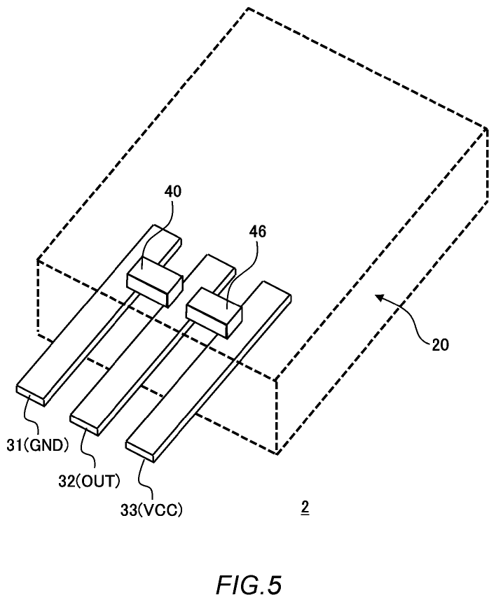

The effects of the pressure sensor apparatus 1 of the present embodiment, which is configured as described above, will be explained in comparison with the comparative example FIG. 5 illustrates the pressure sensor apparatus 2 in the comparative example. In the pressure sensor apparatus 2 of the comparative example, the ground terminal 31, the first terminal 32, and the second terminal 33 are arranged in the order of the ground terminal 31, the first terminal 32, and the second terminal 33 outside the case 20. This point is common to the embodiments of the present invention shown in FIG. 1 to FIG. 3. However, the capacitor is arranged to span between terminals that are adjacent. Accordingly, although the capacitor 40 for the first terminal is provided between the ground terminal 31 and the first terminal 32, the capacitor for the second terminal can not be directly arranged between the ground terminal 31 and the second terminal 33. Accordingly, the capacitor 46 is arranged between the first terminal 32 and the second terminal 33. In the comparative example shown in FIG. 5, the first terminal 32 is the output terminal OUT, the second terminal 33 is the power source terminal VCC.

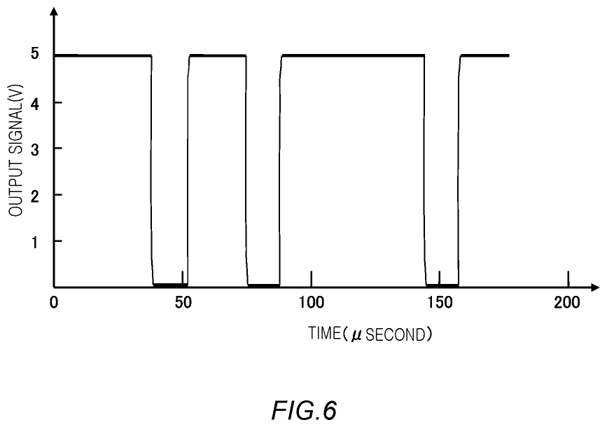

FIG. 6 illustrates one example of the output signal by the pressure sensor apparatus 1 in one embodiment of the present invention. In FIG. 6, a digital signal (a square wave) is output from the output terminal OUT in response to the measured pressure. In FIG. 6, in the pressure sensor apparatus 1 shown in FIG. 1 to FIG. 3, the first terminal 32 is the output terminal OUT, the second terminal 33 is the power source terminal VCC, the electrostatic capacitance of the capacitor 41 for the second terminal between the ground terminal 31 and the power source terminal VCC is 10 nF, and the electrostatic capacitance of the capacitor 40 for the first terminal between the ground terminal 31 and the output terminal OUT is 1 nF. The electrostatic capacitance of the capacitor 40 for the first terminal is determined based on the time constant calculated so that the digital signal (the square wave) output from the output terminal OUT is a waveform read by the subsequent receiving apparatus. The electrostatic capacitance of the capacitor 41 for the second terminal is selected in response to the noise to be reduced.

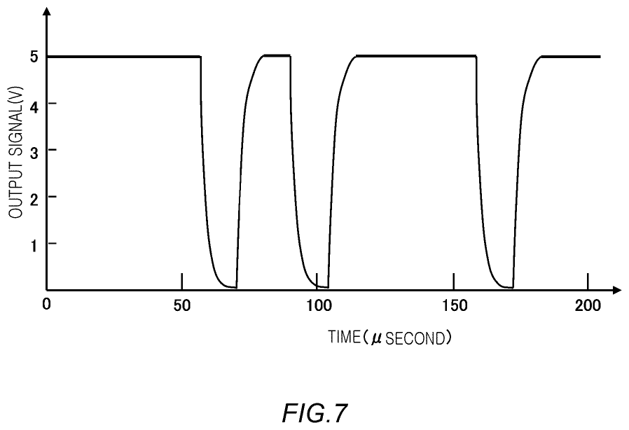

FIG. 7 illustrates one example of the output signal by the pressure sensor apparatus 2 in the comparative example. In FIG. 7, the digital signal (the square wave) is output from the output terminal OUT in response to the measured pressure. In the pressure sensor apparatus 2 shown in FIG. 5, the first terminal 32 is the output terminal OUT, and the second terminal 33 is the power source terminal VCC. The electrostatic capacitance of the capacitor 40 for the first terminal between the ground terminal 31 and the output terminal OUT is 10 nF, and the electrostatic capacitance of the capacitor 46 between the output terminal OUT and the power source voltage VCC is 10 nF. The electrostatic capacitance of the capacitor 40 and the capacitor 46 for the first terminal are selected in response to the noise to be reduced. In the pressure sensor apparatus 2 shown in FIG. 5, the electrostatic capacitance of the capacitor 40 for the first terminal between the ground terminal 31 and the output terminal OUT, and the electrostatic capacitance of the capacitor 46 between the output terminal OUT and the power source voltage VCC must be increased together so that the noise of the high frequency in the power source terminal VCC escape to the ground terminal 31. As a result, the electrostatic capacitance of the capacitor 40 for the first terminal between the ground terminal 31 and the output terminal OUT in the pressure sensor apparatus 2 of the comparative example becomes larger compared with the electrostatic capacitance of the capacitor 40 for the first terminal between the ground terminal 31 and the output terminal OUT in the pressure sensor apparatus 1 of the present embodiment. As a result, the time constant becomes larger, and the rounding of waveform of the output signal becomes larger due to the effect of the electrostatic capacitance of the capacitor 40 for the first terminal.

As shown in FIG. 6 and FIG. 7, when compared with the output signal of the pressure sensor apparatus 2 in the comparative example shown in FIG. 7, the output signal of the pressure sensor apparatus 1 in one embodiment of the present invention shown in FIG. 6 has the rounding of waveform becomes less. In the pressure sensor apparatus 2 in the comparative example, as shown in FIG. 7, the square wave (pulse waveform) is stagnant. If this rounding of waveform exceeds the limit of the subsequent receiving apparatus, the receiving apparatus may not be able to receive the signal. In contrast, according to the pressure sensor apparatus 1 in one embodiment of the present invention, the rising edge of the square wave is output without being stagnant.

As described above, according to the pressure sensor apparatus 1 of the present embodiment, the noise reduction is not limited to the case where the first terminal 32 and the second terminal 33 are arranged on both sides of the ground terminal 31 with reference to the ground terminal 31 outside the case 20, but can be achieved regardless of the terminal arrangement. Since there is no need to form a capacitor in the pressure sensor chip 12 and no need to install a capacitor for noise removal outside the case 20, the number of components can be reduced.

According to the pressure sensor apparatus 1 of the present embodiment, the rounding of waveform can be suppressed while reducing the noise. Accordingly, when outputting the digital signal from the output terminal OUT, the rounding of waveform of the square wave (the pulse waveform) can be suppressed, and the digital signal can be reliably received and processed by the receiving apparatus.

According to the pressure sensor apparatus 1 of the present embodiment, the electrostatic capacitance of the capacitor between the ground terminal and the output terminal OUT can be independently selected as the electrostatic capacitance of the capacitor between the ground terminal and the power source terminal, regardless of the terminal arrangement. Accordingly, it is possible to select an electrostatic capacitance that has a reduced impact on the output signal.

Also, the capacitor 40 for the first terminal, the capacitor 41 for the second terminal, the capacitor 42 for the temperature compensation terminal, the capacitor 43 for the auxiliary terminal and the capacitor 44 for the auxiliary terminal can be arranged to be embodied below the wall portion 24 of the case 20 or in the interior of the wall portion 24. Accordingly, even when stress is applied to the case 20, the region where the capacitor 40 for the first terminal, the capacitor 41 for the second terminal, the capacitor 42 for the temperature compensation terminal, the capacitor 43 for the auxiliary terminal, and the capacitor 44 for the auxiliary terminal are mounted is not easily affected by the deformation of the case 20.

It should be noted that the pressure sensor apparatus 1 of the present invention is arranged in the order of the ground terminal 31, the first terminal 32, and the second terminal 33 on the outside of the case 20, and it may be sufficient to include a capacitor 41 for the second terminal arranged across the ground terminal 31 and the second terminal 33 in between on the inside of the case 20, for example, the second terminal 33 may be extended inside the case 20 instead of the ground terminal 31.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

### EXPLANATION OF REFERENCES

1: pressure sensor apparatus; 2: pressure sensor apparatus; 10: pressure sensor unit; 11: support substrate; 12: pressure sensor chip; 13: diaphragm structure; 14: sealed space; 15: electrode pad; 16: bonding wire; 17: adhesive material; 20: case; 22: base portion; 24: wall portion; 26: concave portion; 27: inner surface; 28: protectant; 30: lead terminal; 31: ground terminal; 32: first terminal; 33: second terminal; 34: temperature compensation terminal; 35: auxiliary terminal; 36: auxiliary terminal; 37: auxiliary terminal; 38: auxiliary terminal; 40: capacitor for the first terminal; 41: capacitor for the second terminal; 42: capacitor for temperature compensation terminal; 43: capacitor for the auxiliary terminal; 44: capacitor for the auxiliary terminal; 46: capacitor; 100: pressure sensor portion; 101: first surface; 102: second surface; 103: edge; 104: edge; 105: edge; 110: control circuit portion; 310: first extending portion; 311: first wire routing portion; 312: first pad portion; 313: first extending portion; 320: second extending portion; 321: second wire routing portion; 322: second pad portion; 323 second extending portion

What is claimed is:

1. A pressure sensor apparatus, comprising:
a pressure sensor unit configured to convert pressure into an electrical signal;
a case configured to house the pressure sensor unit; and
a plurality of lead terminals configured to be exposed toward outside of the case,
wherein
the plurality of lead terminals include at least a first terminal, corresponding to one of an output terminal configured to output a signal based on the electrical signal and a power source terminal configured to supply electrical power to the pressure sensor unit, a second terminal corresponding to another one of the output terminal and the power source terminal, and a ground terminal;
the ground terminal, the first terminal and the second terminal are arranged in an order of the ground terminal, the first terminal, and the second terminal outside the case; and
the pressure sensor apparatus includes a capacitor for a second terminal arranged across the ground terminal and the second terminal in between in interior of the case.

2. The pressure sensor apparatus according to claim 1, further comprising a capacitor for a first terminal arranged between the ground terminal and the first terminal in interior of the case.

3. The pressure sensor apparatus according to claim 2, wherein the capacitor for the first terminal and the capacitor for the second terminal are arranged on a back surface of the lead terminal.

4. The pressure sensor apparatus according to claim 2, wherein:
the case includes a base portion having the pressure sensor unit arranged therein, and a wall portion protruding from the base portion to surround the pressure sensor unit; and
the capacitor for the first terminal and the capacitor for the second terminal are respectively arranged in a position overlapping with the wall portion in a top view.

5. The pressure sensor apparatus according to claim 3, wherein:
the case includes a base portion having the pressure sensor unit arranged therein, and a wall portion protruding from the base portion to surround the pressure sensor unit; and
the capacitor for the first terminal and the capacitor for the second terminal are respectively arranged in a position overlapping with the wall portion in a top view.

6. The pressure sensor apparatus according to claim 4, wherein the ground terminal is configured to extend up to a position where the capacitor for the second terminal and the wall portion overlap to each other in a top view.

7. The pressure sensor apparatus according to claim 5, wherein the ground terminal is configured to extend up to a position where the capacitor for the second terminal and the wall portion overlap to each other in a top view.

8. The pressure sensor apparatus according to claim 4, wherein:
one end of the ground terminal is exposed toward outside of the case;
another end of the ground terminal is divided into a first extending portion and a second extending portion;
the first extending portion and the second extending portion are arranged to sandwich the pressure sensor unit; and
the first extending portion and the second extending portion are respectively configured to extend up to the wall portion.

9. The pressure sensor apparatus according to claim 5, wherein:
one end of the ground terminal is exposed toward outside of the case;
another end of the ground terminal is divided into a first extending portion and a second extending portion;
the first extending portion and the second extending portion are arranged to sandwich the pressure sensor unit; and
the first extending portion and the second extending portion are respectively configured to extend up to the wall portion.

10. The pressure sensor apparatus according to claim 1, wherein:
one end of the ground terminal is configured to be exposed toward outside of the case; and
another end of the ground terminal is configured to extend along at least three edges of the pressure sensor unit.

11. The pressure sensor apparatus according to claim 2, wherein:
one end of the ground terminal is configured to be exposed toward outside of the case; and
another end of the ground terminal is configured to extend along at least three edges of the pressure sensor unit.

12. The pressure sensor apparatus according to claim 3, wherein:
one end of the ground terminal is configured to be exposed toward outside of the case; and
another end of the ground terminal is configured to extend along at least three edges of the pressure sensor unit.

13. The pressure sensor apparatus according to claim 4, wherein:
one end of the ground terminal is configured to be exposed toward outside of the case; and
another end of the ground terminal is configured to extend along at least three edges of the pressure sensor unit.

14. The pressure sensor apparatus according to claim 5, wherein:
one end of the ground terminal is configured to be exposed toward outside of the case; and
another end of the ground terminal is configured to extend along at least three edges of the pressure sensor unit.

15. The pressure sensor apparatus according to claim 6, wherein:
one end of the ground terminal is configured to be exposed toward outside of the case; and
another end of the ground terminal is configured to extend along at least three edges of the pressure sensor unit.

16. The pressure sensor apparatus according to claim 7, wherein:
one end of the ground terminal is configured to be exposed toward outside of the case; and
another end of the ground terminal is configured to extend along at least three edges of the pressure sensor unit.

17. The pressure sensor apparatus according to claim 8, wherein:
one end of the ground terminal is configured to be exposed toward outside of the case; and
another end of the ground terminal is configured to extend along at least three edges of the pressure sensor unit.

18. The pressure sensor apparatus according to claim 9, wherein:
one end of the ground terminal is configured to be exposed toward outside of the case; and
another end of the ground terminal is configured to extend along at least three edges of the pressure sensor unit.

19. The pressure sensor apparatus according to claim 1, wherein:
the case includes a first surface having the ground terminal exposed, the first surface sandwiching the pressure sensor unit and a second surface positioned on an opposite side;
the plurality of lead terminals further include a plurality of auxiliary terminals configured to be exposed from the second surface; and
the pressure sensor apparatus further includes a capacitor for an auxiliary terminal arranged between the ground terminal and at least some of the plurality of auxiliary terminals in interior of the case.

20. The pressure sensor apparatus according to claim 19, wherein the plurality of auxiliary terminals include a first auxiliary terminal group connected to the ground terminal via the capacitor for the auxiliary terminal in interior of the case, and a second auxiliary terminal group not connected to the ground terminal via the capacitor for the auxiliary terminal in interior of the case.
